(19) United States
(12) Patent Application Publication
(10) Pub. No.: US 2014/0103667 A1
(43) Pub. Date: Apr. 17, 2014

(54) EXTERIOR PANEL INTERLOCK

(71) Applicant: McLaren Automotive Limited, Surrey (GB)

(72) Inventor: Dan Parry-Williams, Surrey (GB)

(73) Assignee: McLaren Automotive Limited, Surrey (GB)

(21) Appl. No.: 13/975,222

(22) Filed: Aug. 23, 2013

(30) Foreign Application Priority Data
Oct. 11, 2012 (GB) 1218264.8

(51) Int. Cl. E05B 65/12

(52) U.S. Cl. CPC E05B 83/34; E05B 83/28
USPC 292/137

(57) ABSTRACT

According to an aspect of the invention there is provided a latching mechanism for securing exterior panels, the mechanism comprising a security element moveable between a plurality of configurations and arranged such that when a first exterior panel is fitted in place: in a first configuration the security element engages a first fixed element to latch the first exterior panel in place; and in a second configuration the security element releases the first exterior panel and physically obstructs the fitting of a second exterior panel in place adjacent to the first exterior panel.

### CROSS-REFERENCE TO RELATED APPLICATION(S)

This application claims priority to and the benefit of United Kingdom Application No. GB 1218264.8, filed on Oct. 11, 2012. The entire disclosure of the above application is expressly incorporated by reference in its entirety.

### BACKGROUND

The present invention relates to latching mechanisms.

More specifically, an aspect of the invention relates to apparatus for securing exterior panels, for example of vehicles such as cars.

There is often a need to securely close exterior panels over openings. This may be to seal an internal cavity against environmental conditions such as wind and rain, to hold panels in place during transit or for storage, or for a variety of other reasons.

In the example of a vehicle such as an automobile, exterior panels may be partially or fully removable for a range of reasons. Such panels may cover various components. Exterior panels may be transparent, translucent or opaque. They may be fully removable, or partially removable; for example they could be hinged. They could be isolated, or adjacent to other panels.

Examples of partially or fully removable automobile panels include rear window glass which may be removable for cleaning or to gain access to interior components, e.g. an oil filler cap or a replaceable oil filter. Such a glass panel needs to be securely held in place to make the car weather-tight. Another exterior panel may be used to cover a fuel tank filler chute to prevent water or dust entering the fuel tank or fuel leaving the tank. Such a panel could be a flap permanently connected to the car on one side by a hinge.

There is a particular requirement for exterior panels to be held securely in place during motion of high performance sports/racing vehicles such as cars, motorbikes and sports boats. A loosely secured flap or removable closure could be forced fully open at speed by airflow over the vehicle and so broken or lost. In addition, exterior panels are usually required to be held flush with the vehicle body during motion to preserve the aerodynamic properties of its design. In such vehicles (and other situations) exterior panels may be located adjacent one another, for example to reduce the complexity of a design for ease of manufacture or to reduce the number of grooves/cracks present at panel edges for aerodynamic reasons.

What is needed is a mechanism for securing an exterior panel adjacent another exterior panel.

### SUMMARY

According to an aspect of the invention, there is provided a latching mechanism for securing exterior panels, the mechanism comprising a security element moveable between a plurality of configurations and arranged such that when a first exterior panel is fitted in place: in a first configuration the security element engages a first fixed element to latch the first exterior panel in place; and in a second configuration the security element releases the first exterior panel and physically obstructs the fitting of a second exterior panel in place adjacent to the first exterior panel.

The latching mechanism may further comprise biasing means arranged to, when the security element is in the second configuration, make the failure of the fitting of the second exterior panel unmistakeably visible, considering the context of the exterior panels.

The latching mechanism may be arranged such that the security element is accessible for movement between the plurality of configurations when the second exterior panel is not in place.

The security element may have a channel along at least part of its length for engaging the first fixed element.

The security element may be moveable between the first and second configurations by rotation about an axis.

The security element may have a cross section along at least part of its length in a plane substantially perpendicular to the channel and the axis which has a greater extent from the axis in a first direction than in a second, different direction. The cross section may be generally C-shaped.

The security element may be moveable between the first and second configurations by hand.

The latching mechanism may be arranged such that, when the security element is in the first configuration, the second exterior panel may be latched in place.

The latching mechanism may be arranged such that, when the security element is in the first configuration, a keeper element coupled to the second exterior panel engages a second fixed element to latch the second exterior panel in place.

The second fixed element may be the first fixed element.

The first exterior panel may be fully removable.

The second exterior panel may be a flap on a fixed hinge.

The biasing means may comprise a sprung strut.

The biasing means may comprise a handle for causing the security element to move between the first and second configurations.

The first exterior panel may be a window.

The second exterior panel may be provided for closing a vehicle fuel tank.

### BRIEF DESCRIPTION OF DRAWINGS

Aspects of the present invention will now be described by way of example with reference to the accompanying figures. In the figures:

FIG. 1 illustrates an example use of the invention;

FIG. 2a illustrates an example lock mechanism in locked configuration;

FIG. 2b illustrates the example lock mechanism of FIG. 2a in unlocked configuration;

FIG. 3 shows an end-on cross section of an example security element;

FIG. 4a illustrates another example lock mechanism in locked configuration;

FIG. 4b illustrates the example lock mechanism of FIG. 4a in unlocked configuration; and

FIG. 5 is a flowchart illustrating use of an example lock mechanism.

### DETAILED DESCRIPTION

The following description is presented to enable any person skilled in the art to make and use the system, and is provided in the context of a particular application. Various modifications to the disclosed embodiments will be readily apparent to those skilled in the art.

The general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

There will now be described an example locking mechanism for exterior panels having the dual functionality of, when locked, holding a first exterior panel securely in place and permitting a second exterior panel to be put in place adjacent the first, and, when unlocked, preventing the second exterior panel from being put in place.

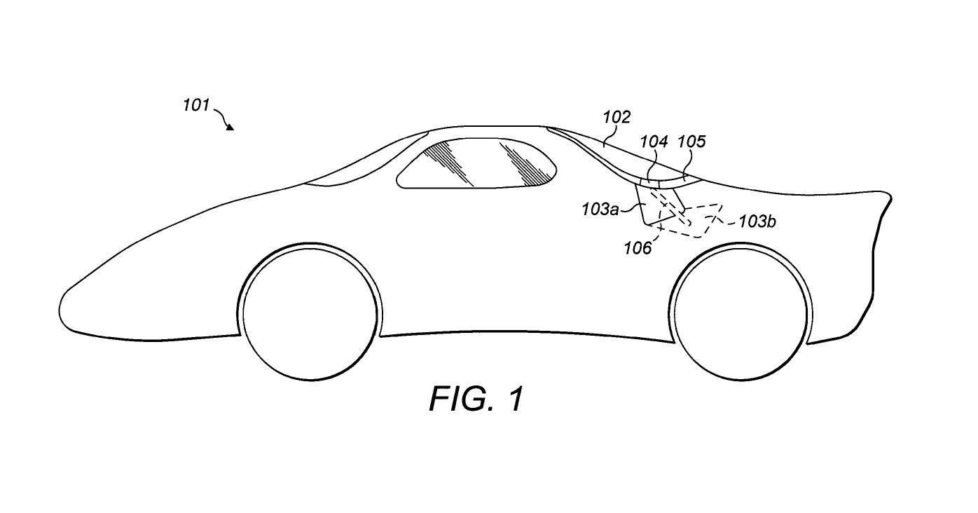

FIG. 1 shows how such a mechanism may be installed on a sports car 101. The car 101 has a first exterior panel, for example rear window 102 comprising a glass panel which is removable for cleaning and/or for accessing an oil filter. The window 102 is adjacent a second exterior panel, for example fuel filler flap 103 which can be opened to permit filling of a fuel tank. Fuel filler flap 103 is shown in its closed position outlined with a solid line at 103a and in its open position outlined with a broken line at 103b.

The car has a latching mechanism 104 for holding the window 102 in place. The latching mechanism could be attached to rim 105 of the window so that it is removable from the car with the window. The latching mechanism 104 has a locked configuration and an unlocked configuration. It could be in an unlocked configuration when the glass of the window 102 is in place. Then the rim 105 would be simply sitting in a recess in the car body and, without the latching mechanism being locked, the window would not be held to the car 101 in a secure manner.

As will be described in more detail below, the design of the latching mechanism 104 is such that when it is in its unlocked configuration it physically obstructs the fuel filler flap 103 so that fuel filler flap 103 cannot be closed. The fuel filler flap 103 may be biased away from its closed position, for example by a sprung strut 106, so that if it is not securely closed it is fully, and/or very visibly, open. In this manner fuel filler flap 103 will be open if the window 102 is not secured, so the car's driver and/or a person performing fuel filling and/or maintenance of the car will be alerted to the fact that the window 102 is not secured and can rectify this before the car is driven away. The biasing means therefore preferably bias the fuel filler flap to an unmistakeably open position.

The design of the latching mechanism 104 is such that when, alternatively, the latching mechanism 104 is in a locked configuration, it latches the window 102 securely in place on the car 101. In this configuration the latching mechanism 104 does not obstruct closing of the fuel filler flap 103. The fuel filler flap 103 may then be closed and locked in place either with a second latching mechanism or with an extension of latching mechanism 104.

It may be preferable for the latching mechanisms for the window 102 and fuel filler flap 103 to be integral with one another, or share components, in order to save space, weight and cost. Alternatively, it may be more convenient to locate them separately.

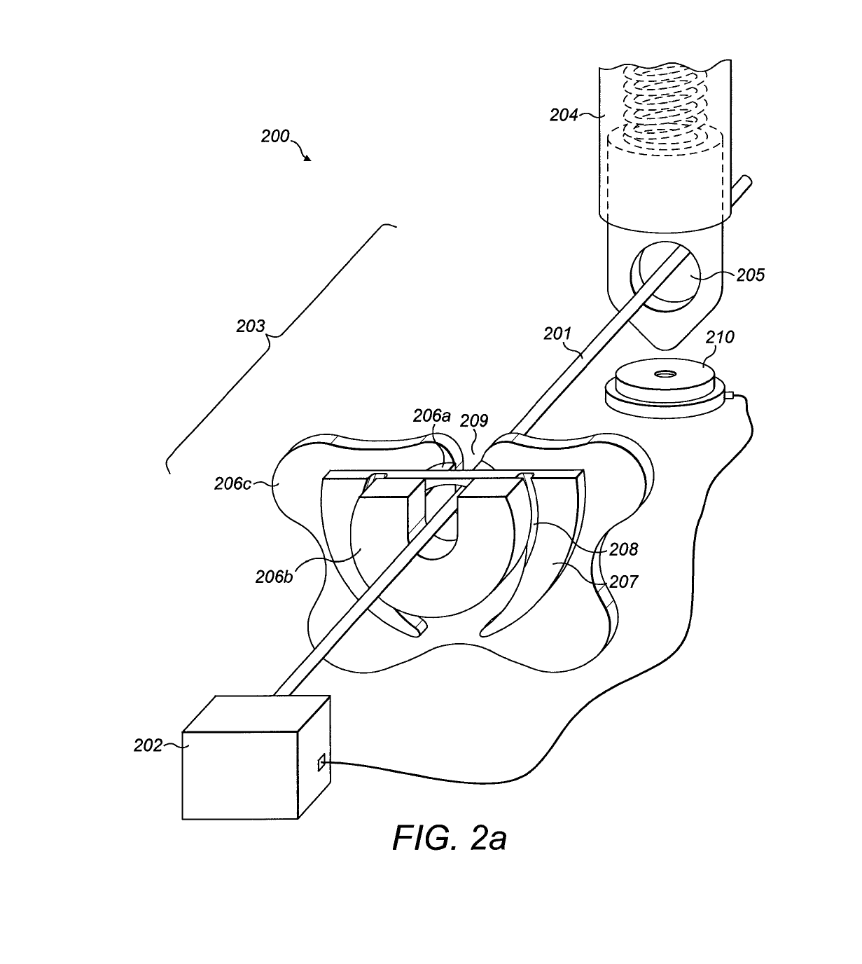

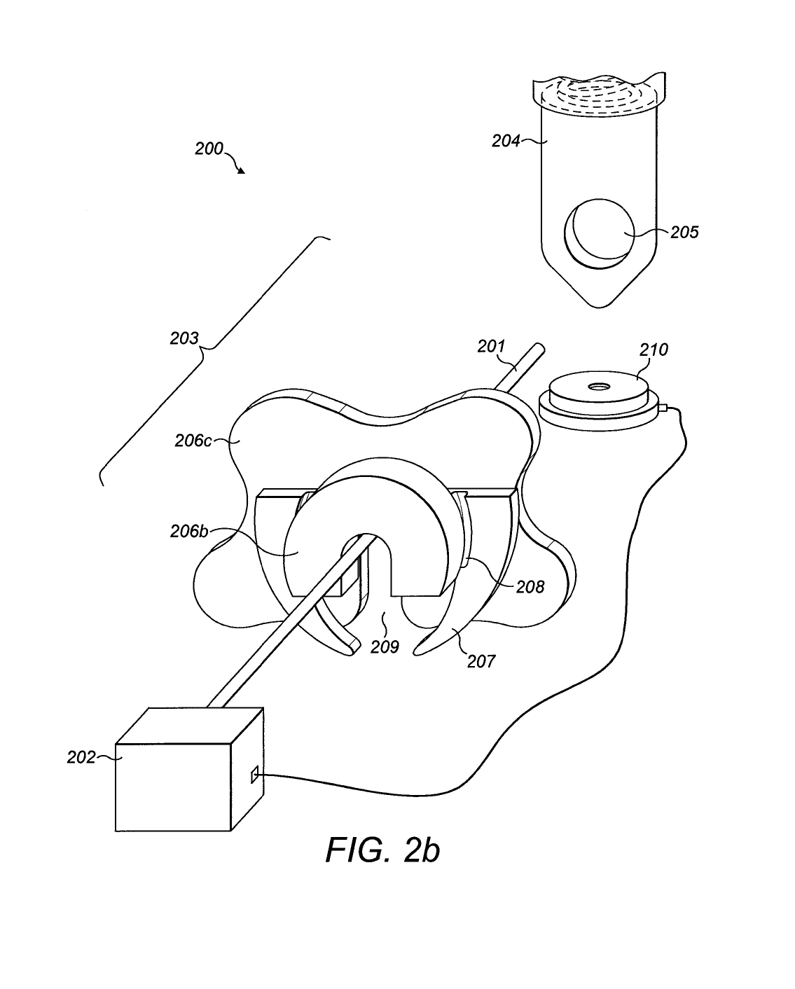

An example of a latching mechanism such as may be used for latching mechanism 104, or in another context, is shown in FIG. 2. In FIGS. 2a and 2b the context, i.e. the apparatus to which various elements of the mechanism are coupled (for example the body of a vehicle, a window and a fuel filler flap on the exterior of that vehicle) is omitted for clarity. FIG. 2a illustrates the mechanism in the locked configuration and FIG. 2b illustrates it in the unlocked configuration.

The latching mechanism of FIGS. 2a and 2b is shown generally at 200. It comprises a locking rod or pin 201. The locking rod is coupled via an actuator 202 to a fixed object (relative to the moving parts of the mechanism) such as the body of a vehicle (not shown). The latching mechanism 200 also includes a security element such as the rotary catch mechanism shown generally at 203 and a block 204 having a bore 205. The rotary catch mechanism 203 is mounted to a first exterior panel of the fixed object (e.g. the removable rear window of a car, not shown) and can be operated to secure the first exterior panel to the locking rod 201 and thus to the fixed object (not shown). The block 204 is mounted to a second exterior panel of the fixed object (e.g. a fuel filler flap, not shown) and can be engaged by the locking rod 201 through the bore 205 to secure the second exterior panel shut.

The rotary catch mechanism 203 comprises a rotatable clasp 206 and a claw 207 which is mounted to the first exterior panel (not shown). The rotatable clasp 206 can rotate relative to the claw 207 about an axis which, when the first exterior panel is in place, is aligned with the locking rod 201.

The rotatable clasp 206 is held captive by the claw 207. Claw 207 partially encircles a stem portion 206a of the rotatable clasp 206. Claw 207 has sufficient space between its pincer ends to receive the locking rod 201 but not to release the stem portion 206a, thus the rotatable clasp 206 cannot escape the claw by radial motion through the gap between the pincer ends. The rotatable clasp 206 is prevented from escaping the claw by axial motion by virtue of the end portions 206b and 206c of the rotatable clasp 206 extending radially outwards further than the inner periphery of the claw 207 in some regions. During assembly, the clasp could be snap-fitted into the claw.

The rotary catch mechanism 203 may further comprise a circlip 208 which holds the rotatable clasp 206 in place against the claw 207. Circlip 208 rotates with the rotatable clasp 206 so that when the rotatable clasp 206 is rotated to its unlocked configuration as shown in FIG. 2b, the entire rotary catch mechanism may be lifted free of locking rod 201.

One of the end portions of rotatable clasp 206, shown in the Figures as 206c, is configured with an irregular radial surface to permit it to be gripped and turned readily by hand, thus causing rotation of the entire rotatable clasp 206 (together with the circlip 208) about its axis.

The rotatable clasp 206 is of generally C-shaped cross-section when viewed axially. That is, a major portion of the rotatable clasp 206 extends circumferentially around its rotation axis (the lower portion as shown in FIG. 2a), but the rotatable clasp 206 is incomplete beyond its rotation axis in a minor portion due to a recess or open channel 209 for receiving locking rod 201 which extends radially from the periphery to the centre of the rotatable clasp 206 in that minor portion (the upper portion as shown in FIG. 2a).

The second exterior panel (not shown) is configured to close over the rotary catch mechanism 203 such that it can be fully closed when the rotary catch mechanism 203 is in its locked configuration as in FIG. 2a, but not when it is in its unlocked configuration as in FIG. 2b.

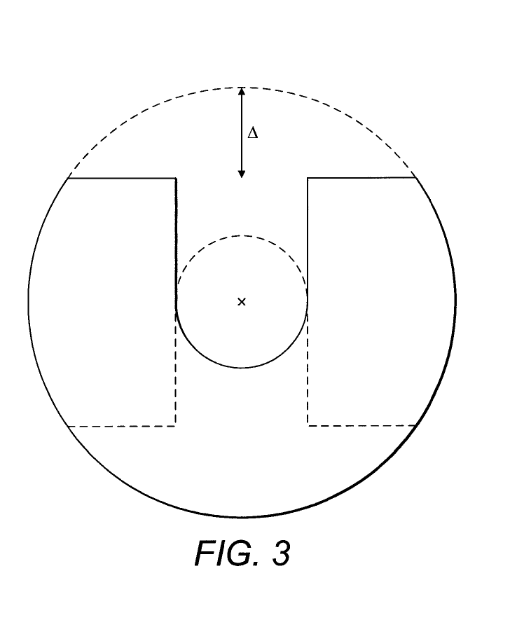

FIG. 3 illustrates a cross-section of rotatable clasp 206 to show how this works. End portion 206b has a cross-section in a plane perpendicular to the axis of rotation of rotatable clasp 206 as shown, where the axis of rotation is marked with an X. The cross-section is largely circular, but with a segment removed from one side and a channel protruding from that side towards the centre. The solid outline is of the end portion 206b in its locked configuration. The broken outline is of the end portion 206b in its unlocked configuration. There is a difference Δ in the highest extent of end portion 206b between the two configurations shown.

Returning to FIG. 2, block 204 is shown in this example as a sprung strut coupled to the second exterior panel and having a bore 205 close to the end not coupled to the second exterior panel for receiving locking rod 201. When the rotatable clasp 206 is in its unlocked configuration, the second exterior panel cannot be pushed far enough for bore 205 in sprung strut 204 to align with the locking rod 201, therefore the sprung strut 204 forces the second exterior panel away from the first exterior panel. (In the automobile example of FIG. 1, the fuel flap pops open.)

When the rotatable clasp 206 is in its locked configuration, the second exterior panel can be pushed down onto the channel-side face of the rotatable clasp 206 so that sprung strut 204 activates actuator 202. Activation may be by means of pushing a button 210 which causes the actuator 202 to extend the locking rod 201 through the bore 205 in the free end of the sprung strut 204 so that the sprung strut 204, and thus the second exterior panel to which it is coupled, are latched in place.

The second exterior panel may then be released by pushing on the second exterior panel so that sprung strut 204 is forced down onto button 210 again, activating actuator 202 to withdraw locking rod 201 from the bore 205 in sprung strut 204. With the second exterior panel out of the way, rotatable clasp 206 may then be rotated to unlock the first exterior panel which can then be removed.

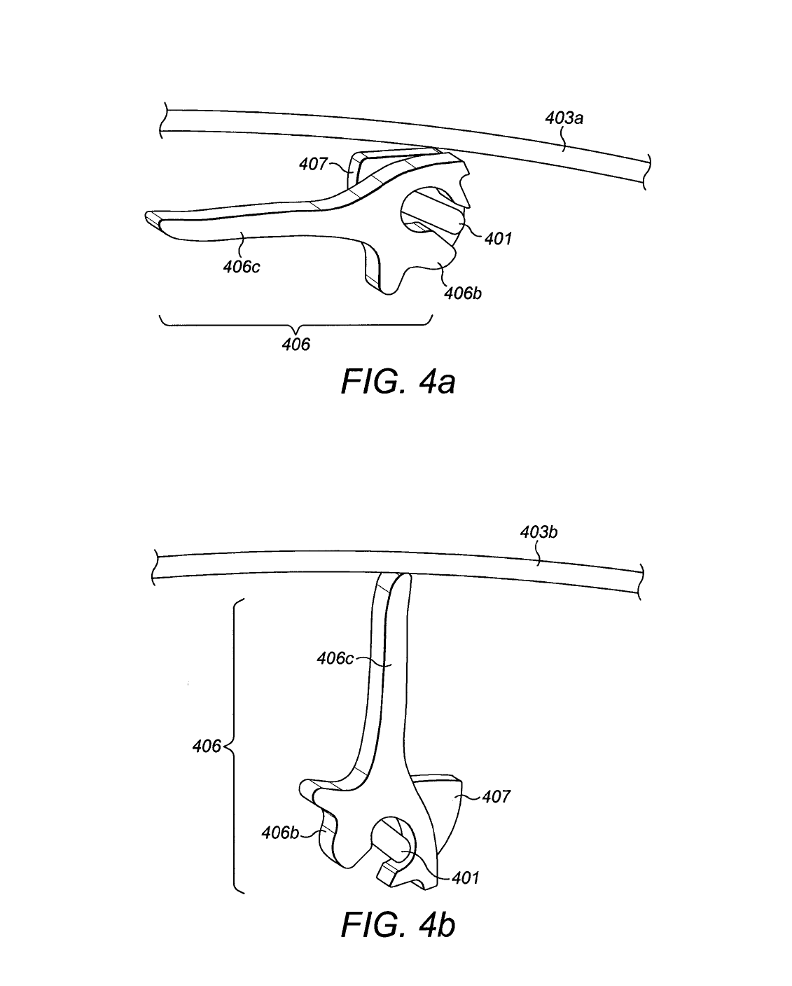

FIG. 4 shows an example locking mechanism in which the second exterior panel (e.g. fuel filler flap), shown at 403a in its closed position and at 403b in its open position, is propped open when rotatable clasp 406 is in its unlocked configuration. This is due to the elongated shape of handle 406c, which may be grasped and rotated by hand to move rotatable clasp 406 between locked and unlocked configurations as shown in FIGS. 4a and 4b respectively. The elongated shape of handle 406c acts to exaggerate the effect of the height difference Δ shown in FIG. 3. Handle 406c may be formed as part of rotatable clasp 406 together with keeper portion 406b as shown, or may be attached to it. Locking rod 401 and claw 407 are similar to locking rod 201 and claw 207 of FIG. 2 respectively. Further details have been omitted for clarity, but could be similar to those shown in FIG. 2. The length of handle 406c may be sufficient to prop the second exterior panel open enough to be clearly visible. Alternatively or additionally, the length of handle 406c may be sufficient for the mechanical advantage in a spring mechanism similar to sprung strut 204 to make the second exterior panel open wide.

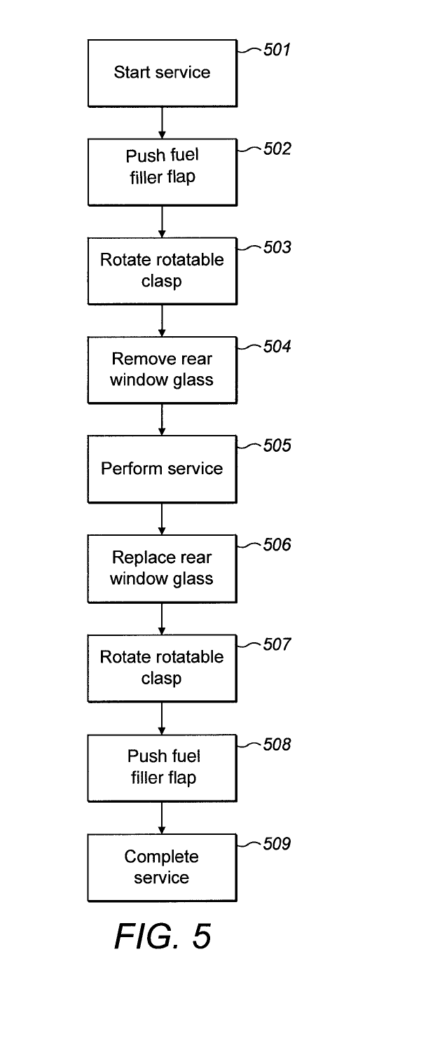

FIG. 5 is a flowchart describing a method of operation of the mechanism shown in FIG. 2 when servicing a car in which it is installed for locking the fuel filler flap and rear window glass. At 501 the car arrives for a service. At 502 the fuel filler flap is pushed to release it. At 503 the rotatable clasp is rotated 180 degrees to release the rear window glass. At 504 the rear window glass is removed. At 505 the rear window glass is cleaned and any components accessible through the rear window, e.g. an oil filter, are serviced. (The fuel tank may also be filled at this point or at any other time between steps 502 and 508.) At 506 the rear window glass is replaced. At 507 the rotatable clasp is rotated 180 degrees to lock the rear window glass in place. At 508 the fuel filler flap is pushed down to lock it. At 509 the service is complete.

The invention is not limited to use in cars, motorbikes, boats or any other vehicles, but may be used in any situation requiring the securing of multiple adjacent external panels.

A keeper part(s) of a latching mechanism according to the invention may be coupled to the external panels and a latching part(s) may be fixed (e.g. rotary catch mechanism 203, and block 204 mounted on the rear window panel rim and fuel filler flap respectively and the locking rod 201 coupled to the car body as per the example above). Alternatively, the keeper part(s) may be fixed with a latching part coupled to each exterior panel.

Means for biasing the second exterior panel away from its closed position are optional. Such means may be provided as a spring, for example a coil or bow spring near the hinge axis of the panel or as a sprung strut. Such a sprung strut may suitably comprise a helical spring or gas spring. The biasing means in the example described above also acts as keeper for a latch for the second exterior panel. This is preferable in terms of saving weight and space, but it may be more convenient in some situations to have separate keeper and biasing means, for example block 204 could be a readily manufactured block with a bore 205 for receiving locking rod 201, and an “off the shelf” push-push mechanism could be provided separately.

The rotatable clasp may be rotatable by hand, by use of a particular tool which may be specially provided for the purpose or by a generic/readily available tool for example pliers, a spanner or an Allen (hex) key. Arrangement of the rotatable clasp for rotation by hand or by a readily available tool provides the advantage that a specialised tool need not be located, making the operation of locking or unlocking the first exterior panel quicker. However it may be preferable to limit this operation to being performed by a person in possession of a specialised tool for security purposes. For example the security element may be movable between locked and unlocked configurations only by a particular key, e.g. in the car example described above a key used to open the driver's door and start the ignition of the car may be used. This would prevent a thief gaining access to the car by simply popping the fuel flap from the exterior of the car using the push-push mechanism described, turning the rotatable clasp and removing the rear window glass. The engine would also have to be switched off before the rear window glass could be removed as the necessary key would have to be removed from the ignition.

Further convenience could be provided in the example described above by adding a further control for the fuel flap lock. The actuator 206 may be activated not only using the push-push mechanism, but also by pushing a button/flicking a switch/selecting an option on an on-board computer or similar in the interior of the car. Additionally/alternatively, further security may be provided by making it necessary to unlock a further latch mechanism on the pin 202 and/or prime the actuator 206 using an in-car control before it can be activated.

The locked and unlocked configurations of the rotary catch need not be 180 degrees apart, but this provides the advantage that the mechanism is less likely to slip open by accident than for smaller angular separations.

The security element need not be a rotary catch as in the example described above. It could, for example, comprise sliding parts or hinged elements instead.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A latching mechanism for securing exterior panels, the mechanism comprising a security element moveable between a plurality of configurations and arranged such that when a first exterior panel is fitted in place:
in a first configuration the security element engages a first fixed element to latch the first exterior panel in place; and
in a second configuration the security element releases the first exterior panel and physically obstructs the fitting of a second exterior panel in place adjacent to the first exterior panel.

2. A latching mechanism as claimed in claim 1, further comprising biasing means arranged to, when the security element is in the second configuration, make the failure of the fitting of the second exterior panel unmistakeably visible, considering the context of the exterior panels.

3. A latching mechanism as claimed in claim 1, arranged such that the security element is accessible for movement between the plurality of configurations when the second exterior panel is not in place.

4. A latching mechanism as claimed in claim 1, wherein the security element has a channel along at least part of its length for engaging the first fixed element.

5. A latching mechanism as claimed in claim 1, wherein the security element is moveable between the first and second configurations by rotation about an axis.

6. A latching mechanism as claimed in claim 4, wherein the security element is moveable between the first and second configurations by rotation about an axis; and wherein the security element has a cross section along at least part of its length in a plane substantially perpendicular to the channel and the axis which has a greater extent from the axis in a first direction than in a second, different direction.

7. A latching mechanism as claimed in claim 6, wherein the cross section is generally C-shaped.

8. A latching mechanism as claimed in claim 1, wherein the security element is moveable between the first and second configurations by hand.

9. A latching mechanism as claimed in claim 1, arranged such that, when the security element is in the first configuration, the second exterior panel may be latched in place.

10. A latching mechanism as claimed in claim 9, arranged such that, when the security element is in the first configuration, a keeper element coupled to the second exterior panel engages a second fixed element to latch the second exterior panel in place.

11. A latching mechanism as claimed in claim 10, wherein the second fixed element is the first fixed element.

12. A latching mechanism as claimed in claim 1, wherein the first exterior panel is fully removable.

13. A latching mechanism as claimed in claim 1, wherein the second exterior panel is a flap on a fixed hinge.

14. A latching mechanism as claimed in claim 2 wherein the biasing means comprises a sprung strut.

15. A latching mechanism as claimed in claim 2 wherein the biasing means comprises a handle for causing the security element to move between the first and second configurations.

16. A latching mechanism as claimed in claim 1, wherein the first exterior panel is a window.

17. A latching mechanism as claimed in claim 1, wherein the second exterior panel is provided for closing a vehicle fuel tank.
